(19) United States
(12) Patent Application Publication
(10) Pub. No.: US 2017/0352037 A1
(43) Pub. Date: Dec. 7, 2017

(54) Identification and Payment Method Using Biometric Characteristics

(71) Applicant: Top Victory Investments Ltd., Kowloon (HK)

(72) Inventor: Tim Wu, New Taipei City (TW)

(21) Appl. No.: 15/172,190

(22) Filed: Jun. 3, 2016

(51) Int. Cl. G06Q 20/40; H04N 5/225

(52) U.S. Cl. CPC G06Q 20/40145; H04N 5/225

(57) ABSTRACT

An identification and payment method of using biometric characteristics is provided. It uses different combinations of different kinds of biometric characteristics of an individual to verify or authenticate the individual to pay different amounts of money to enhance security. In addition, if the individual is under coercion or the individual's biometric characteristics are usurped, it may communicate with, for example, external organizations, third-party devices, or social contacts of the individual to enhance security.

### BACKGROUND OF THE INVENTION

### 1. Field of the Invention

The present invention relates to an identification and payment method. More particularly, the present invention relates to an identification and payment method using biometric characteristics.

### 2. Description of the Prior Art

A conventional identification and payment method uses, for example, a password or smart card for identification of an individual. The password or smart card is convenient to use, but it is not secure because it is easily forgotten, lost, stolen, usurped, or intentionally shared with other individual.

As technologies advance, biometric characteristics such as fingerprints, finger veins, and irises are becoming easier to capture and recognize. Another conventional identification and payment method using biometric characteristics is becoming popular as a means to combine convenience and security. It is convenient because an individual can be verified or authenticated using biometric characteristics rather than memorized data, and it is secure because biometric characteristics are unique to that specific individual and cannot be reverse engineered.

However, the conventional identification and payment method using biometric characteristics does not use different combinations of different kinds of biometric characteristics of an individual to verify or authenticate the individual to pay different amounts of money to enhance security. In addition, if the individual is under coercion or the individual's biometric characteristics are usurped, it does not communicate with, for example, external organizations, third-party devices, or social contacts of the individual to enhance security.

### SUMMARY OF THE INVENTION

The present invention provides an identification and payment method using biometric characteristics, which is capable of using different combinations of different kinds of biometric characteristics of an individual to verify or authenticate the individual to pay different amounts of money, and communicating with, for example, external organizations, third-party devices, or social contacts of the individual if the individual is under coercion or the individual's biometric characteristics are usurped, so as to enhance security.

According to an aspect of the present invention, there is provided an identification and payment method including: according to an amount of money to be paid by an individual, requesting the individual to provide at least one biometric characteristic; comparing the at least one biometric characteristic provided by the individual with biometric characteristics of enrolled individuals stored in a database to determine whether the individual belongs to the enrolled individuals; if the individual belongs to the enrolled individuals, determining whether the at least one biometric characteristic provided by the individual includes an alarm biometric characteristic preset by the individual and stored in the database; and, if the at least one biometric characteristic provided by the individual includes the alarm biometric characteristic, presuming that the individual is under coercion, and thereby generating deceptive payment information to the individual, and generating alarm information to a police department to report or a financial institution to freeze a collection account.

According to another aspect of the present invention, the identification and payment method further includes: if the at least one biometric characteristic provided by the individual includes the alarm biometric characteristic, activating an image capturing device to record an ambient image of the individual to the police department or the financial institution. Moreover, the image capturing device may include a third-party image capturing device.

According to another aspect of the present invention, the identification and payment method further includes: if the at least one biometric characteristic provided by the individual includes the alarm biometric characteristic, activating a positioning device to record a current position of the individual to the police department or the financial institution.

According to another aspect of the present invention, the identification and payment method further includes: if the at least one biometric characteristic provided by the individual includes the alarm biometric characteristic, transmitting a short message preset by the individual and stored in the database to telephones of social contacts of the individual. Moreover, the individual and the social contacts thereof may have different places of residence.

According to another aspect of the present invention, the identification and payment method further includes: if the individual belongs to the enrolled individuals, activating a positioning device to record a current position of the individual. Moreover, the identification and payment method further includes: comparing the current position of the individual with a position preset by the individual and stored in the database to determine whether the current position of the individual is the position preset by the individual. Moreover, the identification and payment method further includes: if the current position of the individual is not the position preset by the individual, presuming that the at least one biometric characteristic provided by the individual is usurped, and thereby generating the alarm information to the police department to report or the financial institution to freeze a payment account.

According to another aspect of the present invention, the at least one biometric characteristic provided by the individual includes a fingerprint, a finger vein, or an iris. In an embodiment, if the amount of money is less than a first threshold, the at least one biometric characteristic provided by the individual includes the fingerprint; if the amount of money is greater than or equal to the first threshold and less than a second threshold, the at least one biometric characteristic provided by the individual includes the fingerprint and the finger vein; if the amount of money is greater than or equal to the second threshold, the at least one biometric characteristic provided by the individual includes the fingerprint, the finger vein, and the iris.

### BRIEF DESCRIPTION OF THE DRAWINGS

FIG. 1 is a flowchart of requesting an individual to provide at least one biometric characteristic according to an amount of money to be paid by the individual according to an embodiment of the present invention.

FIG. 2 is a flowchart of an identification and payment method according to an embodiment of the present invention.

FIG. 3 is a flowchart of an identification and payment method according to another embodiment of the present invention.

### DESCRIPTION OF THE PREFERRED EMBODIMENTS

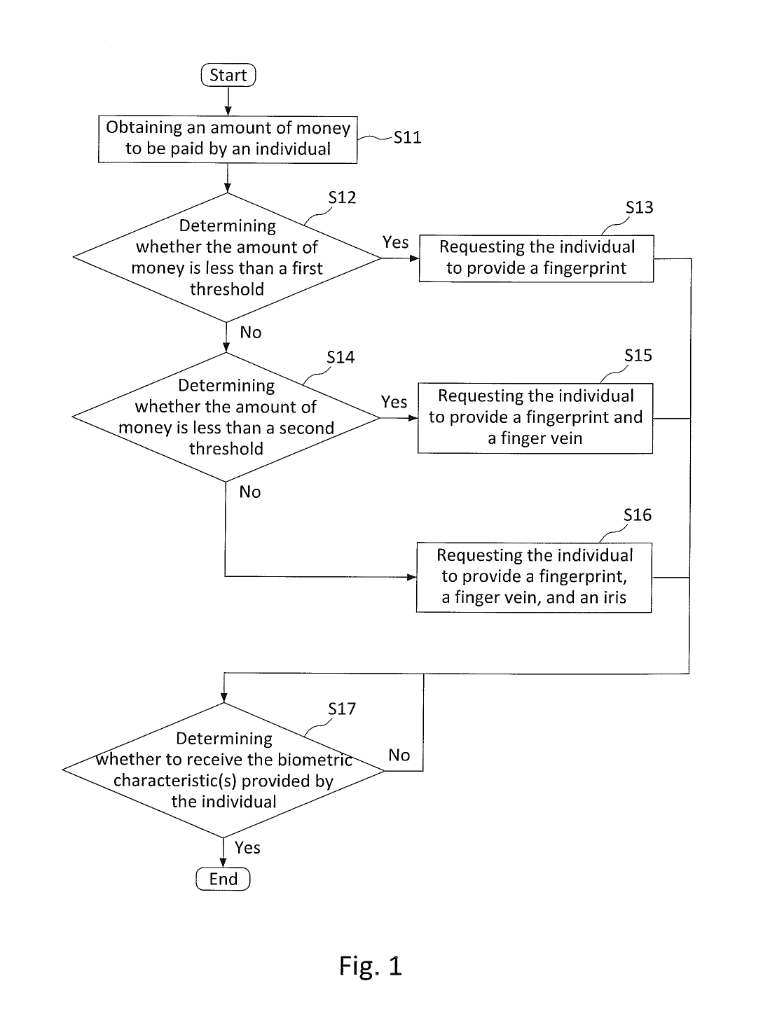

Referring to FIG. 1, there is shown a flowchart of requesting an individual to provide at least one biometric characteristic according to an amount of money to be paid by the individual according to an embodiment of the present invention. At step S11, when an individual buys a product or service, an amount of money to be paid by the individual is obtained by a computer system. The individual may pay with, for example, cash or credit cards online or offline. The computer system may include an automated teller machine (ATM), a point of sale (POS) machine, or a virtual reality (VR) device.

At step S12, the computer system determines whether the amount of money is less than a first threshold, and, if yes, executes step S13; if no, executes step S14.

At step S13, the computer system determines that the amount of money is less than the first threshold, so it requests the individual to provide a biometric characteristic to verify or authenticate the individual. In the embodiment, the biometric characteristic requested to be provided by the individual is a fingerprint.

At step S14, the computer system determines that the amount of money is not less than (i.e. greater than or equal to) the first threshold, so it further determines whether the amount of money is less than a second threshold, and, if yes, executes step S15; if no, executes step S16.

At step S15, the computer system determines that the amount of money is less than the second threshold while being greater than or equal to the first threshold, so it requests the individual to provide two kinds of biometric characteristics to verify or authenticate the individual. In the embodiment, the biometric characteristics requested to be provided by the individual are a fingerprint and a finger vein.

At step S16, the computer system determines that the amount of money is not less than (i.e. greater than or equal to) the second threshold, so it requests the individual to provide three kinds of biometric characteristics to verify or authenticate the individual. In the embodiment, the biometric characteristics requested to be provided by the individual are a fingerprint, a finger vein, and an iris.

After completion of step S13, S15, or S16, the computer system executes step S17. At step S17, the computer system determines whether to receive the biometric characteristic(s) provided by the individual, and, if no, keeps on executing step S17 to wait for the individual to provide the biometric characteristic(s); if yes, ends this process shown in FIG. 1.

In other words, the amount of money is divided into three sections by using the first and second thresholds. Assuming the amount of money is expressed as $ while the first and second thresholds are respectively expressed as TH1 and TH2, the three sections are $<TH1, TH1≦$<TH2, and TH2≦$. In the section of $<TH1, the individual only needs to provide a biometric characteristic to be verified because the amount of money is relatively small. In the section of TH1≦$<TH2, the individual needs to provide two kinds of biometric characteristics to be verified. In the section of TH2≦$, the individual needs to provide three kinds of biometric characteristics to be verified because the amount of money is relatively large. Therefore, the individual needs to provide various combinations of three kinds of biometric characteristics to be verified.

It should be known that the embodiment is not intended to be limited to the present invention. For example, the amount of money may be divided into M sections by using (M−1) thresholds, wherein M is an integer greater than 3. The individual may need to provide various combinations of N kinds of biometric characteristics to be verified, wherein N is an integer greater than 3. As the sections of the amount of money to be paid by the individual increase, the kinds of biometric characteristics requested to be provided by the individual increase.

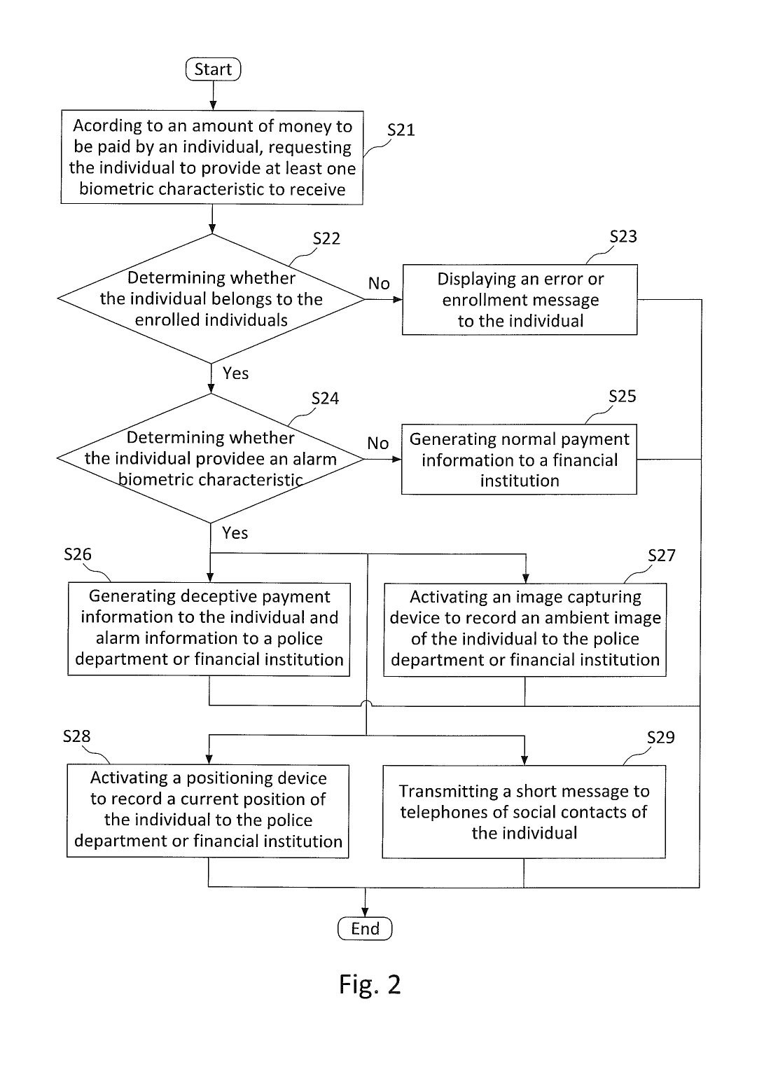

Referring to FIG. 2, there is shown a flowchart of an identification and payment method according to an embodiment of the present invention. At step S21, when an individual buys a product or service, an amount of money to be paid by the individual is obtained by a computer system. According to the amount of money to be paid by the individual, the computer system requests the individual to provide at least one biometric characteristic, and, if receiving the biometric characteristic(s) provided by the individual, executes next step S22. In the embodiment, step S21 is, but not limited to, implemented by using the process shown in FIG. 1.

At step S22, the computer system compares the biometric characteristic(s) provided by the individual with biometric characteristics of enrolled individuals stored in a database of the computer system to determine whether the individual belongs to the enrolled individuals, and, if no, executes step S23; if yes, executes step S24. It should be explained that biometric characteristics of an individual are captured and stored in the database during an enrollment process, and then the individual becomes an enrolled individual.

At step S23, the computer system determines that the individual does not belong to the enrolled individuals, so it displays an error message to the individual that s/he provides error biometric characteristics, or displays an enrollment message to the individual that s/he is not enrolled and needs to be enrolled in advance. Then, the computer system ends this process shown in FIG. 2. If the individual provides error biometric characteristics, s/he may immediately restart this process from the beginning step S21. If the individual is not enrolled, s/he needs to be an enrolled individual through the enrollment process, and then may start this process from the beginning step S21.

At step S24, the computer system determines that the individual belongs to the enrolled individuals, so it further determines whether the biometric characteristic(s) provided by the individual includes an alarm biometric characteristic preset by the individual and stored in the database, and, if no, executes step S25; if yes, presumes that the individual is under coercion, and thereby executes steps S26, S27, S28, and S29. The alarm biometric characteristic includes, for example, a middle fingerprint or finger vein. It should be known that the embodiment is not intended to be limited to the present invention. For example, when the computer system determines that the biometric characteristic(s) provided by the individual includes the alarm biometric characteristic preset by the individual, it may execute at least one of steps S26, S27, S28, and S29.

At step S25, the computer system determines that the biometric characteristic(s) provided by the individual does not include the alarm biometric characteristic, so it generates normal payment information to a financial institution to cooperate in this transaction, and then ends this process shown in FIG. 2.

At step S26, the computer system presumes that the individual is under coercion, and thereby generates deceptive payment information to the individual, so the individual may use the deceptive payment information to provisionally cheat some person, people or entity that coerces the individual without substantially pecuniary loss. Moreover, the computer system generates alarm information to a police department to report so that the police may go to help the individual, or generates alarm information to a financial institution to freeze a collection account owned by some person, people or entity that coerces the individual.

At step S27, the computer system presumes that the individual is under coercion, and thereby activates an image capturing device to record an ambient image of the individual to the police department or the financial institution. The image capturing device may be a component of the computer system, or a third-party image capturing device.

At step S28, the computer system presumes that the individual is under coercion, and thereby activates a positioning device to record a current position of the individual to the police department or the financial institution.

At step S29, the computer system presumes that the individual is under coercion, and thereby transmits a short message to telephones of social contacts of the individual, wherein the short message is preset by the individual and stored in the database. The social contacts of the individual may do something to help the individual. Preferably, the individual and the social contacts thereof have different places of residence.

After completion of step S26, S27, S28, or S29, the computer system ends this process shown in FIG. 2.

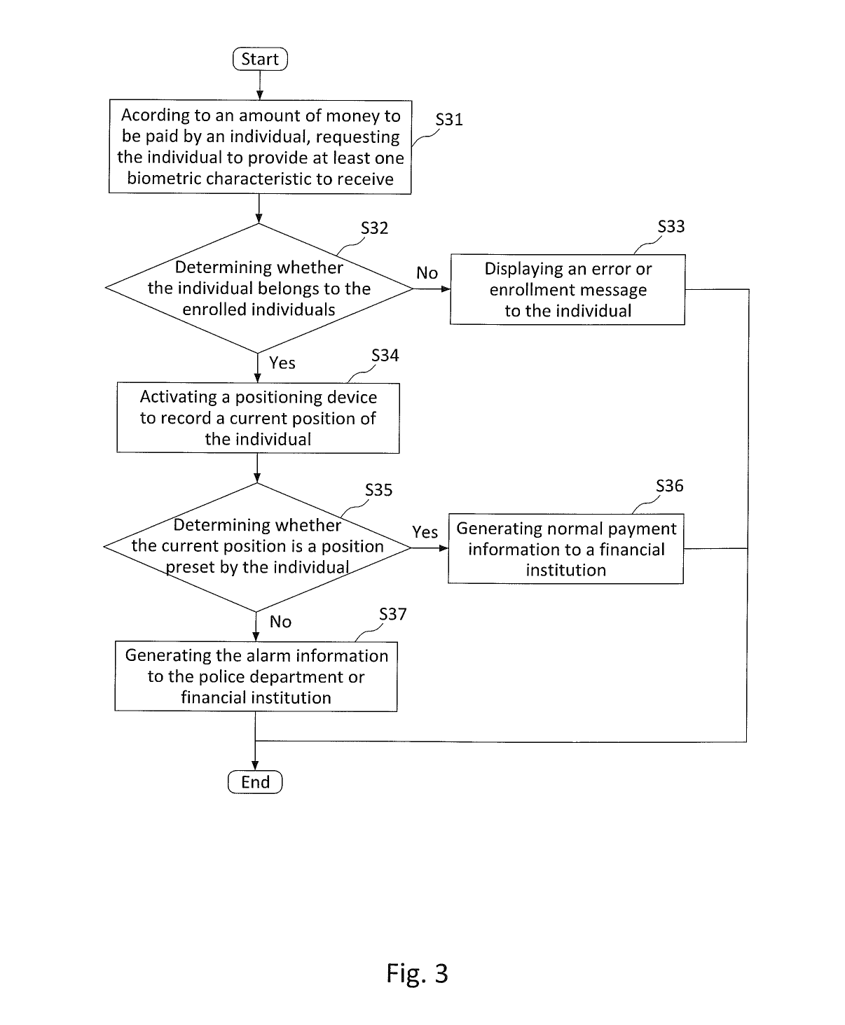

Referring to FIG. 3, there is shown a flowchart of an identification and payment method according to another embodiment of the present invention. In the embodiment, steps S31, S32, and S33 are, but not limited to, implemented by using steps S21, S22, and S23 shown in FIG. 2, respectively.

At step S34, the computer system determines that the individual belongs to the enrolled individuals, so it activates a positioning device to record a current position of the individual.

At step S35, the computer system compares the current position of the individual with a position preset by the individual and stored in the database to determine whether the current position of the individual is the position preset by the individual, and, if yes, executes step S36; if no, presumes that the biometric characteristic(s) provided by the individual is usurped, and thereby executes step S37.

In the embodiment, step S36 is, but not limited to, implemented by using step S25 shown in FIG. 2.

At step S37, the computer system presumes that the biometric characteristic(s) provided by the individual is usurped, and thereby generates the alarm information to the police department to report, or generates the alarm information to the financial institution to freeze a payment account owned by the individual or a collection account owned by a usurper.

After completion of step S36 or S37, the computer system ends this process shown in FIG. 3.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. An identification and payment method comprising:
according to an amount of money to be paid by an individual, requesting the individual to provide at least one biometric characteristic;
comparing the at least one biometric characteristic provided by the individual with biometric characteristics of enrolled individuals stored in a database to determine whether the individual belongs to the enrolled individuals;
if the individual belongs to the enrolled individuals, determining whether the at least one biometric characteristic provided by the individual comprises an alarm biometric characteristic preset by the individual and stored in the database; and
if the at least one biometric characteristic provided by the individual comprises the alarm biometric characteristic, presuming that the individual is under coercion, and thereby generating deceptive payment information to the individual, and generating alarm information to a police department to report or a financial institution to freeze a collection account.

2. The identification and payment method of claim 1 further comprising: if the at least one biometric characteristic provided by the individual comprises the alarm biometric characteristic, activating an image capturing device to record an ambient image of the individual to the police department or the financial institution.

3. The identification and payment method of claim 2, wherein the image capturing device comprises a third-party image capturing device.

4. The identification and payment method of claim 1 further comprising: if the at least one biometric characteristic provided by the individual comprises the alarm biometric characteristic, activating a positioning device to record a current position of the individual to the police department or the financial institution.

5. The identification and payment method of claim 1 further comprising: if the at least one biometric characteristic provided by the individual comprises the alarm biometric characteristic, transmitting a short message preset by the individual and stored in the database to telephones of social contacts of the individual.

6. The identification and payment method of claim 5, wherein the individual and the social contacts thereof have different places of residence.

7. The identification and payment method of claim 1 further comprising: if the individual belongs to the enrolled individuals, activating a positioning device to record a current position of the individual.

8. The identification and payment method of claim 7 further comprising: comparing the current position of the individual with a position preset by the individual and stored in the database to determine whether the current position of the individual is the position preset by the individual.

9. The identification and payment method of claim 8 further comprising: if the current position of the individual is not the position preset by the individual, presuming that the at least one biometric characteristic provided by the individual is usurped, and thereby generating the alarm information to the police department to report or the financial institution to freeze a payment account.

10. The identification and payment method of claim 1, wherein the at least one biometric characteristic provided by the individual comprises a fingerprint, a finger vein, or an iris.

11. The identification and payment method of claim 10, wherein if the amount of money is less than a first threshold, the at least one biometric characteristic provided by the individual comprises the fingerprint.

12. The identification and payment method of claim 11, wherein if the amount of money is greater than or equal to the first threshold and less than a second threshold, the at least one biometric characteristic provided by the individual comprises the fingerprint and the finger vein.

13. The identification and payment method of claim 12, wherein if the amount of money is greater than or equal to the second threshold, the at least one biometric characteristic provided by the individual comprises the fingerprint, the finger vein, and the iris.

14. The identification and payment method of claim 1 applied to an automated teller machine (ATM), a point of sale (POS) machine, or a virtual reality (VR) device.
